(19) United States
(12) Patent Application Publication
(10) Pub. No.: US 2018/0363605 A1
(43) Pub. Date: Dec. 20, 2018

(54) CONNECTOR FOR FLUID TRANSFER CIRCUITS AND METHOD FOR MANUFACTURING THE SAME

(71) Applicant: MGI COUTIER, Champfromier (FR)

(72) Inventors: Stéphane SANDA, Malemort du Comtat (FR); Luc QUENIN, Mazan (FR)

(73) Assignee: MGI COUTIER, Champfromier (FR)

(21) Appl. No.: 16/012,343

(22) Filed: Jun. 19, 2018

(30) Foreign Application Priority Data
Jun. 20, 2017 (FR) 17/55615

(51) Int. Cl. F02M 37/00; F02M 55/00; F16L 33/18; F16L 33/22

(52) U.S. Cl. CPC F02M 37/0017; F02M 55/004; F02M 2200/853; F16L 33/227; F02M 55/002; F16L 33/18

(57) ABSTRACT

The invention concerns a connector (1) for fluid transfer circuits comprising a main body (2) including:
a first end (2a) equipped with at least one connecting end-piece (3) shaped to cooperate with an element such as an injector,
a second end (2b) comprising a gasket bearing area (Z1) intended to house a sealing gasket (101), said connector (1) further comprising a flange (4) added onto the main body (2), preferably at the second end (2b) of the main body (2).

The invention concerns the field of connectors for fluid transfer circuits for automobiles or heavy trucks and more particularly the technical field of connectors mounted on injectors arranged in their leakage circuit.

Generally, these connectors are mounted on one end to a tubing or, in the case of connectors-injectors, to an injector and on another end on a part called “return ramp” which ensures the recovery of the excess fuel flowing through the injector but which is not sent into the cylinder for combustion. This excess fuel contributes in particular to the cooling and the lubrication of the injector. It is then returned to the tank just like the return of the high-pressure pump.

The connectors are often equipped with a locking device which has been the subject of numerous inventions. The locking device ensures the attachment of the connector on the injector over the entire service life of the vehicle even if it is dismountable for maintenance operations. In addition, a sealing is often achieved via an O-ring gasket housed in a groove arranged on the injector. Most of the connectors at least as regards their main body and particularly the area of the connector housed in the groove of the injector, are made by a single-piece molding and comprise a main body comprising a first end provided with at least an end-piece for connecting to the return ramp and a second end provided with an area referred to as the gasket bearing area, which defines the area in which the O-ring gasket is intended to be positioned and a guiding and retaining flange configured to maintain the gasket in the gasket bearing area.

The disadvantage of such a single-piece design is that the “parting surface” of the part, which designates the visible marks on the part which correspond to the interface between the different portions of the injection mold, extends longitudinally along the main body and passes through the gasket bearing area. This configuration will, upon the one-time molding operation, generate a degradation of the surface condition locally and in some cases, the surface defect can be particularly prominent, which can generate either leaks at the gasket or a notch in the gasket.

In addition, any surface defect on the gasket bearing area limits the sealing performance of the connector, in particular when the latter is subject to specific stresses (lateral force associated with the mounting on vehicle known as “side load”, pulsed pressures, etc.)

The invention aims at overcoming all or part of these disadvantages by proposing an optimized connector design so that the gasket bearing area is as smooth and as homogeneous as possible in order to guarantee the sealing between the connector and the element to which it is connected, for example an injector, without damaging the gasket.

To this end, the object of the invention is a connector for fluid transfer circuits comprising a main body including:
a first end equipped with at least one connecting end-piece shaped to cooperate with an element such as an injector,
a second end comprising a gasket bearing area intended to house a sealing gasket, said connector further comprising a flange added onto the main body preferably at the second end of the main body.

Thanks to this configuration, the connector is made of at least two parts namely the main body on the one hand, and the flange on the other hand, which allows offsetting the parting surface out of the gasket bearing area, in such a way that the parting surface of the main body does not impede the sealing produced by the gasket nor does it damage said gasket during its mounting or its post-mounting use on the connector. Indeed, the presence of the flange in the molding of the main body imposes a parting surface of the connector passing through the gasket bearing area, adding the flange and molding it apart allows offsetting this parting surface.

In addition, the absence of parting surface in the gasket bearing area ensures an optimal surface condition without burr while optimizing the sealing. According to one feature of the invention, the gasket bearing area is devoid of parting surface of the main body of the connector.

According to one embodiment of the invention, the connector is shaped to cooperate with an injector.

According to one feature of the invention, the second end of the connector is equipped with at least one retaining element shaped to receive at least partially at least one section of the flange. The retaining element allows promoting the mechanical hook of the flange on the second end of the main body and ensuring the positioning of said flange on said second end.

According to one feature of the invention, the at least one retaining element is a circumferential groove in which the flange is housed.

Alternatively, the retaining element is a recess in which at least one section of the flange is housed. Preferably, the second end comprises at least two retaining elements in the form of recesses. Preferably, the at least two retaining elements are arranged on the second end in a diametrically opposite manner.

According to one feature of the invention, a first parting surface of the main body is formed at a guiding and centering area of the connector arranged between the first and the second end (2a, 2b) out of the gasket bearing area.

More specifically, the first parting surface separates at least the guiding and centering area of the connector, the gasket bearing area and the second end of the main body from the main body portion greater than the guiding and centering area of the connector.

Even more specifically, the first parting surface separates at least the gasket bearing area and the second end of the main body from the main body portion greater than the gasket bearing area.

These cutouts allow demolding the different shapes of the connector and in particular the protruding shapes, in which is housed for example the retaining ring of the connector.

According to one embodiment of the invention, the main body comprises at least a first body section extending along an axis Y-Y and at least a second body section extending along the axis X-X, the first body section being secant to the second body section.

According to one embodiment of the invention, the main body has at least a second longitudinal parting surface along the axis X-X from one end of the second body section connected to the first body section, to the guiding and centering area of the connector.

According to one feature of the invention, the flange is added by assembly on the second end of the main body. Preferably, the assembly is a clipping, a welding, a snap-riveting or a crimping.

According to one feature of the invention, the flange is overmolded on the second end of the main body with the same material as that of the main body or with a different material.

According to one feature of the invention, the flange has an annular shape or any other shape intended to cooperate with a complementary shape arranged on the main body of the connector.

According to one feature of the invention, the connector comprises a sealing gasket arranged in the gasket bearing area of the connector.

According to one feature of the invention, the sealing gasket is an O-ring gasket.

According to one feature of the invention, the sealing gasket is an added gasket.

The invention also relates to a method for manufacturing a connector according to the invention shaped to cooperate with an injector, the method comprising at least the following steps:
molding of the main body of the connector,
overmolding or assembling the flange on the second end of the main body of the connector.

According to one feature of the invention, the overmolding or the assembling of the flange is carried out under the gasket bearing area of the main body.

Advantageously, the main body comprises at least one retaining element arranged at the second end, preferably under the gasket bearing area, the overmolding or the assembling being carried out on this retaining element.

According to one feature of the invention, the flange is assembled by clipping or welding or snap-riveting or crimping.

According to one embodiment of the invention, in the case of assembling by crimping, the flange is made of metal, such as stainless steel or aluminum.

According to one embodiment of the invention, the material used for the overmolding of the ring and the material used for the molding of the connector body are chemically compatible in order to increase the mechanical strength of the gasket retaining ring, with a chemical bonding of the ring and the body.

Thus, the main body and the ring may each consist of polyamides (PA66, PA4.6, PA6.10, PA12, etc.), or of polyphthalamides (PPA, based on PA4T, PA6T, PA9T, PA10T, PA61, etc.). For said polyphthalamides, different types of copolymers can be used such as 6T/6, 6T/66, 6T/61, 66/61/6T, etc.

According to one embodiment of the invention, it is possible to make one of the main body and the ring of polyamide and the other of polyphthalamide, some grades of these materials being chemically compatible.

Furthermore, other families of materials can be used, for example polysulfonamide (PPS), polyetheretherketone (PEEK) or any other material compatible with the target applications. It is possible according to the invention to choose filled grades, for example to increase the mechanical strength of the material (glass fiber filler, preferably at 30%, glass bead filler, talc filler, etc.), or to make the circuits dissipative of electrostatic charges (for example thanks to carbon black particles, carbon fibers or carbon nanotubes) or any other charge allowing to achieve one or more target performances.

According to the invention and depending on the stresses, it is possible to mix the use of different fillers between the main body of the connector and the overmolded flange.

To this end, the optimization of the chemical bonds can be made for example thanks to an overmolding performed quickly after injection of the body of the connector, when the latter is still hot for example in a rotary mold.

Alternatively, the material used for the flange may not be chemically compatible with the material used for the injection of the main body of the connector. This can allow, for example, obtaining a flange with a low coefficient of friction to facilitate the connection of the connector to the fluid transfer circuit, or obtaining a flange with a particularly hard surface to resist abrasion during the mounting.

According to one embodiment of the invention, the mold allowing the implementation of the manufacturing method according to the invention comprises a first mold portion comprising at least one cavity configured to form at least the gasket bearing area and the second end of the main body of the connector, without longitudinal parting surface.

According to one embodiment of the invention, the cavity of the first mold portion is configured to form the guiding and centering area of the connector, the gasket bearing area and the second end of the main body of the connector.

Advantageously, the first mold portion may be devoid of mold motion, at least the gasket bearing area and the second end of the main body of the connector being demolded naturally or forcefully.

In addition, the first mold portion may comprise retractable pins configured to form a recess-type retaining element, said pins being designed to retract prior to the ejection of the part in order to allow its release.

According to one embodiment of the invention, the mold further comprises a second mold portion comprising at least one cavity configured to form a portion of the main body greater than the gasket bearing area.

According to one embodiment of the invention, the mold further comprises a second mold portion comprising at least one cavity configured to form a portion of the main body greater than the guiding and centering area of the connector.

The invention will be better understood, thanks to the following description, which relates to embodiments according to the present invention, given as non-limiting examples and explained with reference to the appended schematic figures, in which the identical reference number indications correspond to structurally and/or functionally identical or similar elements. The attached schematic figures are listed below:

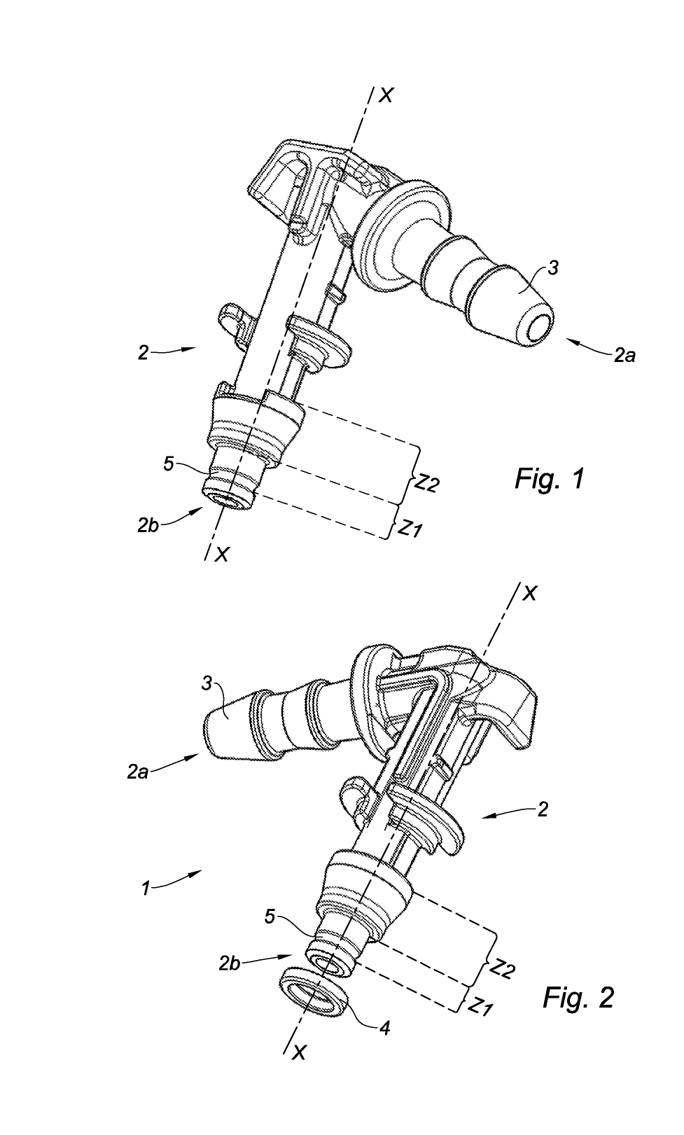

FIG. 1 is a perspective view of the main body of an exemplary connector according to the invention,

FIG. 2 is an exploded perspective view of the connector according to a first embodiment,

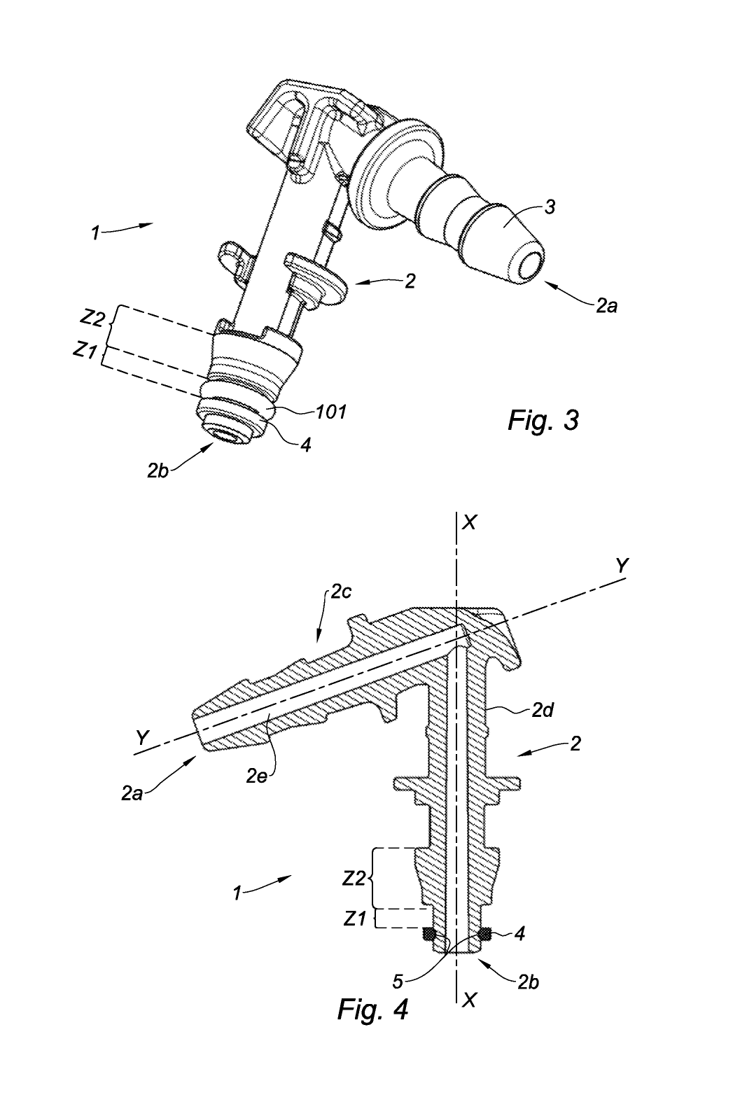

FIG. 3 is a perspective view of the connector as illustrated in FIG. 2 equipped with a sealing gasket, according to the first embodiment,

FIG. 4 is a longitudinal sectional view of the connector according to the first embodiment shown in FIG. 3;

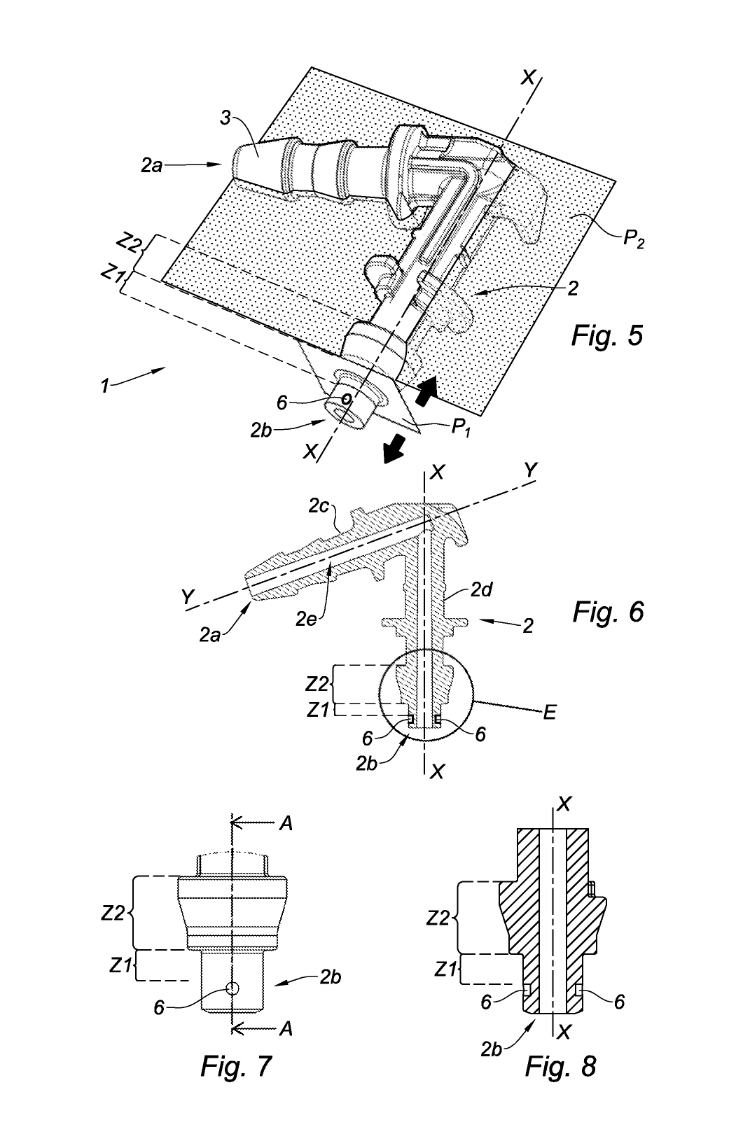

FIG. 5 is a perspective view of the main body of the connector, whatever the embodiment of the connector, with illustration of the first parting surface offset out of the gasket bearing area and of a second parting surface,

FIG. 6 is a longitudinal sectional view of the main body of the connector shown in FIG. 5 according to the second embodiment,

FIG. 7 is a detail view of the second end of the connector shown in FIG. 6 according to the box E,

FIG. 8 is a sectional view of the second end of the connector shown in FIG. 7 along the axis A-A,

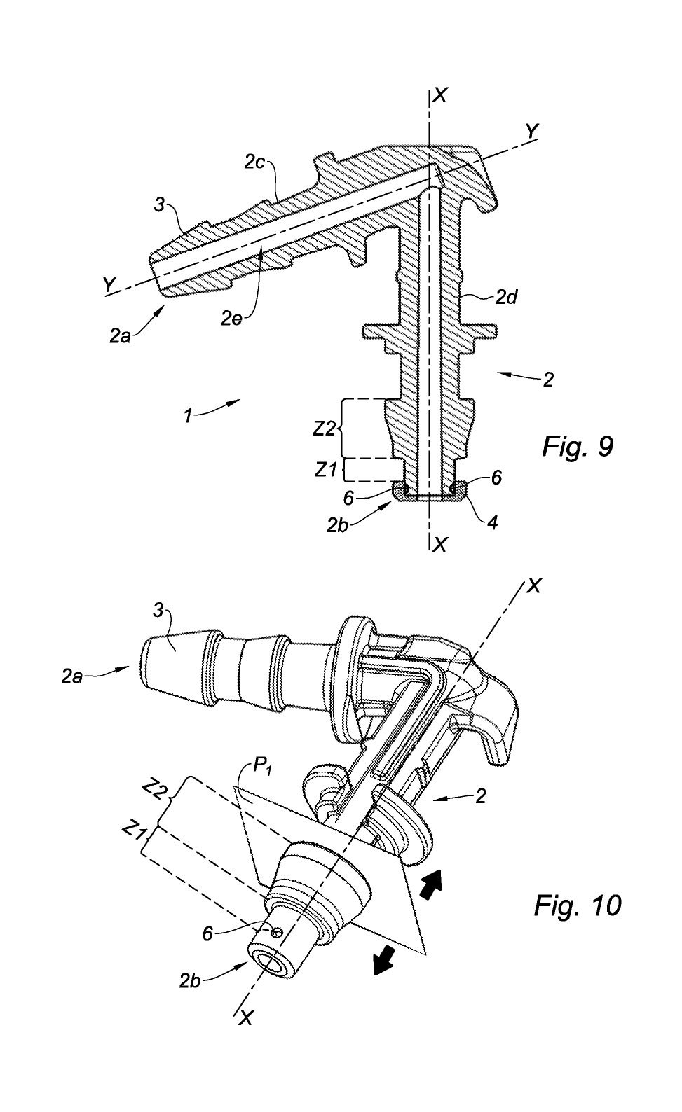

FIG. 9 is a sectional view of the connector comprising a main body such as the one shown in FIG. 6, according to the second embodiment,

FIG. 10 is a perspective view of the main body of the connector according to the invention with an illustration of a first parting surface offset out of the gasket bearing area according to a variant of the second embodiment.

The connector 1 according to the invention comprises a main body 2 extending generally along a longitudinal axis X-X as illustrated in FIG. 1. The main body 2 comprises a first body section 2c extending along an axis Y-Y and a second body section 2d extending along the axis X-X, the first body section 2c being secant to the second body section 2d.

Advantageously and as seen in each cross-section illustrated in FIGS. 4, 6, 9, the first body section 2c and the second body section 2d are fluidly connected via an internal channel 2e. The main body 2 comprises a first end 2a arranged on the first body section 2c. The main body 2 comprises a second end 2b arranged on the second body section 2d.

As seen in the figures showing the connector 1, the first end 2a of the main body 2 is equipped with a connecting end-piece intended to cooperate with a tube or a hose of a return ramp (not shown).

Furthermore, and as illustrated in particular in FIG. 2, the second end 2b comprises a gasket bearing area Z1 intended to house a preferably O-ring sealing gasket 101, illustrated in FIG. 3.

According to the invention, the connector 1 further comprises a flange 4 illustrated in FIG. 2 for example. The flange 4 is annular. The flange 4 is assembled to the main body 2 according to a first embodiment illustrated in FIGS. 3 and 4 or is overmolded on the main body 2 according to a second embodiment as shown in FIG. 9.

According to a first embodiment illustrated in FIGS. 3 and 4, the flange 4 is arranged at the second end 2b of the main body, leaving a section of the second end 2b protruding with respect to the flange 4. In this first configuration, the flange 4 may be overmolded or assembled, for example by clipping.

According to a second embodiment illustrated in particular in FIG. 9, the flange 4 may be arranged on the second end 2b of the main body 2. In this second configuration, the flange 4 is overmolded on the second end 2b.

Whatever the embodiment and as illustrated in particular in FIGS. 1, 2, 4 to 10, the second end 2b of the connector 1 can be equipped with at least one retaining element 5, 6 shaped to receive at least one section of the flange 4.

In the first embodiment and as illustrated in FIGS. 1 and 2, the retaining element is a circumferential groove 5 in which the flange 4 is housed, as seen in FIG. 4. In a variant, not shown, of the first embodiment, the circumferential groove 5 can be replaced by a circumferential bulge, a complementary groove being then arranged on the flange 4. Nevertheless, in this variant, the configuration of the connector 1 complicates the demolding in particular of the end 2b of the connector 1, for example by a forced demolding.

In the second embodiment and as illustrated in FIGS. 5 to 9, the retaining element is a recess element 6 arranged on the second end 2b and in which a section of the flange 4 is housed as shown in FIG. 9. In the present case, there are shown two retaining elements arranged on the second end 2b of the main body 2 in a diametrically opposite manner as illustrated in FIG. 8. Of course, there can be only one retaining element or a plurality of retaining elements. Advantageously, the retaining elements may be preferably disposed in negative relief (recesses) to allow a natural demolding once the pins in the mold making the recesses 6 have retracted to allow the extraction of the second end 2b of the connector 1, as illustrated in FIGS. 6 to 8.

FIG. 5 shows a first parting surface P1 of the main body 2 of the connector 1 schematizing the boundary between a first mold portion forming the gasket bearing area Z1 and the second end 2b of the main body 2 and a second mold portion forming the portion of the main body greater than the gasket bearing area Z1. In addition, a second parting surface P2 is illustrated in FIG. 5 and schematizes the two mold sections of the second mold portion forming the upper portion of the main body 2 of the connector 1, the second parting surface P2 extending substantially along the same longitudinal axis X-X.

FIG. 10 shows a variant in which the first parting surface P1 is positioned upstream of the guiding and centering area Z2 of the connector. Thus, the first parting surface P1 schematizes the boundary between a first mold portion forming the guiding and centering area Z2 of the connector 1, the gasket bearing area Z1 and the second end 2b of the main body 2 and a second mold portion forming the portion of the main body greater than the guiding and centering area Z2 of the connector 1. The second parting surface P2 is not shown but uses the same principle as in FIG. 5.

According to the invention, the connector 1 is made by molding, on the one hand, the main body 2 by injection for example, and by assembling or overmolding, on the other hand, a flange 4 at the second end of the main body 2 and preferably under the gasket bearing area Z1. In this manner, the parting surface P of the main body 2 for the demolding can be offset toward the guiding area Z2 of the connector out of the gasket bearing area Z1.

Of course, the invention is not limited to the embodiments described and shown in the appended figures. Modifications remain possible, in particular from the point of view of the constitution of the various elements or by substitution of technical equivalents, without departing from the protection field of the invention.

1. A connector for fluid transfer circuits comprising a main body including:
a first end equipped with at least one connecting end-piece shaped to cooperate with an element such as an injector,
a second end comprising a gasket bearing area intended to house a sealing gasket, the connector further comprising a flange added onto the main body, at the second end of the main body.

2. The connector according to claim 1, wherein the flange is added by assembly on the second bend of the main body.

3. The connector according to claim 1, wherein the flange is overmolded on the second end of the main body.

4. The connector according to claim 1, wherein the main body and the flange are made of a same or different plastic material.

5. The connector according to claim 1, wherein the second end of the main body is equipped with at least one retaining element shaped to receive the flange.

6. The connector according to claim 5, wherein the one retaining element is a circumferential groove in which the flange is housed.

7. The connector according to claim 5, wherein the retaining element is a recess in which the flange is housed.

8. The connector according to claim 1, wherein a first parting surface of the main body is formed at a guiding and centering area of the connector arranged between the first and second ends out of the gasket bearing area.

9. The connector according to claim 1, comprising a sealing gasket arranged in the gasket bearing area of the connector.

10. A method for manufacturing a connector according to claim 1, the method comprising at least the following steps:
molding the main body of the connector,
overmolding or assembling the flange on the second end of the main body of the connector.

11. The manufacturing method according to claim 10, wherein the overmolding or the assembling of the flange is made under the gasket bearing area of the main body.

12. The manufacturing method according to claim 10, wherein the flange is assembled by clipping or welding or snap-riveting or crimping.
